(19) United States
(12) Patent Application Publication
(10) Pub. No.: US 2004/0185256 A1
(43) Pub. Date: Sep. 23, 2004

(54) Fire retardant wooden slats

(76) Inventor: Lyle Zastrow, Irvine, CA (US)

Correspondence Address: KLEIN, O'NEILL & SINGH, 2 PARK PLAZA, SUITE 510, IRVINE, CA, 92614, US

(21) Appl. No.: 10/393,477

(22) Filed: Mar. 20, 2003

(51) Int. Cl. B05D 3/12

(52) U.S. Cl. 428/411.1; 522/1; 522/174; 427/558; 427/291

(57) ABSTRACT

The present invention relates to fire retardant wooden components and a method of manufacturing a fire retardant-treated wooden component, such as a slat. The method includes the step of pressure treating a piece of lumber with a fire retardant solution; drying the pressure treated piece of lumber to a moisture content of 15-23%; cutting the piece of lumber into wooden components of the desired dimensions; applying a coat of lacquer thinner base to the wooden components; drying the base thinner coat; applying a UV cured sealant coating on the dried base coat; drying the sealant coat; applying a UV cured polyurethane top coat on the sealant coated wooden components; and curing the polymer coating.

### BACKGROUND OF THE INVENTION

The present invention relates to fire retardant wooden components and method of manufacture of fire retardant wooden components, particularly wooden slats, such as the slats used to make wooden blinds and shutters and the like.

Wood is a widely used building material. Wooden components are strong, light weight and easily worked with tools and relatively inexpensive. However, there is an inherent danger of fire associated with the use of wooden components in buildings and in building fixtures.

The treatment of lumber and wooden components with fire retardant solutions to decrease the dangers of fire has been carried out in the past. The treatment with fire retardant solution reduces some static mechanical properties. Further, the fire retardant-treated wood also suffers loss in strength, especially when exposed to elevated temperatures and humidity.

It has been deemed desirable to manufacture wooden components exhibiting fire retardant characteristics without compromising their characteristic strength and static mechanical properties.

### SUMMARY OF THE INVENTION

It is one object of the present invention to provide a method of manufacture of fire retardant-treated wooden components, such as slats used in wooden blinds and shutters.

In a first preferred embodiment of the present invention, the method comprises pressure treating an uncut piece of lumber with a fire retardant solution. The pressure treated lumber is then dried in a kiln to a specific moisture content.

Next, the fire retardant solution-treated piece of lumber is cut into wooden components of the desired width, thickness and length.

In the next step, the fire retardant wooden components are coated with lacquer thinner base stain. The lacquer coated wooden component is then dried at elevated temperatures.

Thereafter, base stain coated wooden slats are coated with a UV cured sealant formulation and then flash cured to dry the coat. A 100% UV cured polyurethane coat is then applied on to the wooden components, followed by flash curing to dry the coating applied.

In yet another aspect of the present invention, a fire retardant wooden component exhibiting an average weight loss of less than 40% when subjected to standard methods of fire tests for flame retardant resistant textiles and films NFPA 701 fire test 1 (small) 1996 Edition is provided.

In a specific embodiment, the fire retardant solution used for treating uncut lumber comprises chemicals that react with combustible gases and tars normally generated by untreated lumber and convert them to carbon char and harmless carbon dioxide and water. The surface char insulates the underlying wood and decreases the rate at which the cross sectional area is reduced. Further, the carbon dioxide and water vapor dilute the combustible gases to help reduce the spreading of the flames.

Furthermore, the lumber is pressure treated with the fire retardant formulation that remains stable in high temperature environments and does not increase the corrosivity of metal hardware in contact with the lumber or the wooden components formed therefrom.

The present invention therefore relates to fire retardant wooden components and a method of manufacturing fire retardant-treated wooden components.

The present invention may be understood through the following description with reference to the accompanying drawings.

### BRIEF DESCRIPTION OF THE DRAWINGS

FIG. 1 is a flow diagram showing various steps for pressure treating lumber with a fire retardant solution followed by slicing and cutting the treated wood to form wooden components of desired length and width, according to the present invention.

FIG. 2 is a flow diagram showing application of a lacquer thinner base formulation, a sealant formulation and a top coat of UV cured polyurethane in accordance with the present invention.

### DETAILED DESCRIPTION OF THE INVENTION

The present invention will now be described in more detail with reference to the following embodiments. It is to be noted that the following descriptions of the preferred embodiments of this invention are presented herein for the purpose of illustration and description only. It is not intended to be exhaustive or to be limited to the precise form disclosed.

In an embodiment of the present invention, the fire retardant solution used in the pressure treatment of the lumber comprises the following essential ingredients:

| INGREDIENT | % by weight | CAS NO: |
|---|---|---|
| Boric Acid | 2-6 | 10043-35-3 |
| Guanylurea Phosphate | 5-14 | 17675-60-4 |
| Phosphoric Acid | 0-0.2 | 7664-38-2 |
| Water | 80-93 | |

The lacquer thinner base formulation as used to apply a base coat on the wooden components, according to one aspect of the present invention comprises the following essential ingredients:

| INGREDIENT | % by weight | CAS NO: |
|---|---|---|
| Light Aliphatic Naphtha | 15-40 | 64742-89-8 |
| Toluene | 15-40 | 108-88-3 |

Besides these essential components, the formulation additionally comprises conventional ingredients selected from surfactants, pigments and/or solvents.

The clear UV-cured sealant formulation as used to apply a second coat on the wooden components, according to one aspect of the present invention comprises the following essential ingredients:

| INGREDIENT | % by weight | CAS NO: |
|---|---|---|
| Acrylated Oligomer | 30-60 | |
| TRPGDA | 10-30 | 042978-66-5 |
| Dipropyleneglycol Diacrylate | 7-13 | 57472-68-1 |
| Photoinitiator | 1-5 | |

The 100% UV-cured polyurethane formulation as used to apply the top coat on the wooden components, according to one aspect of the present invention comprises the following essential ingredients:

| INGREDIENT | % by weight | CAS NO: |
|---|---|---|
| Tripropylene Glycol | 35-45 | 042978-66-5 |
| Diacrylate | | |
| Epoxy Acrylate | 25-35 | 055818-57-0 |
| NPG Propoxylate Diacrylate | 5-15 | 084170-74-1 |
| Benzophenone | 1-5 | 000119-61-9 |
| Trimethylolpropane Triacrylate | 1-5 | 015625-89-5 |
| Acrylated Amine | 1-5 | |
| Hydroxymethylphenylpropanone | 1-5 | 7473-98-5 |
| Hydroxycyclohexylphenyl ketone | 1-5 | 947-19-3 |

Besides these essential components, the formulation additionally comprises other conventional ingredients selected from additives and/or surfactants.

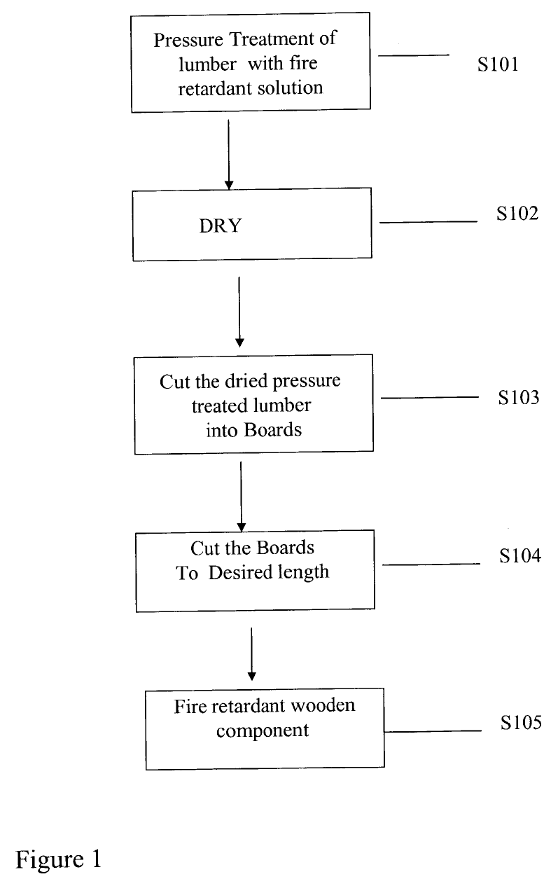

FIG. 1 illustrates the steps for pressure treating a piece of lumber with a fire retardant solution in one aspect of the present invention.

In step S101, the lumber is pressure treated with a fire retardant solution in accordance with the requirements of industrial standards.

In step S102, the fire retardant-treated lumber is kiln dried to a desired moisture content of 15-23 percent. In an exemplary embodiment, the fire retardant-treated lumber is kiln dried to a moisture content of 19 percent.

In step S103, fire retardant-treated lumber is cut into boards of a desired thickness and width. In a preferred embodiment, 0.25 in. (6.35 mm) thick by 2 in. (51 mm) wide boards are cut.

In step S104, the boards are cut to the desired length to form fire retardant-treated wooden slats.

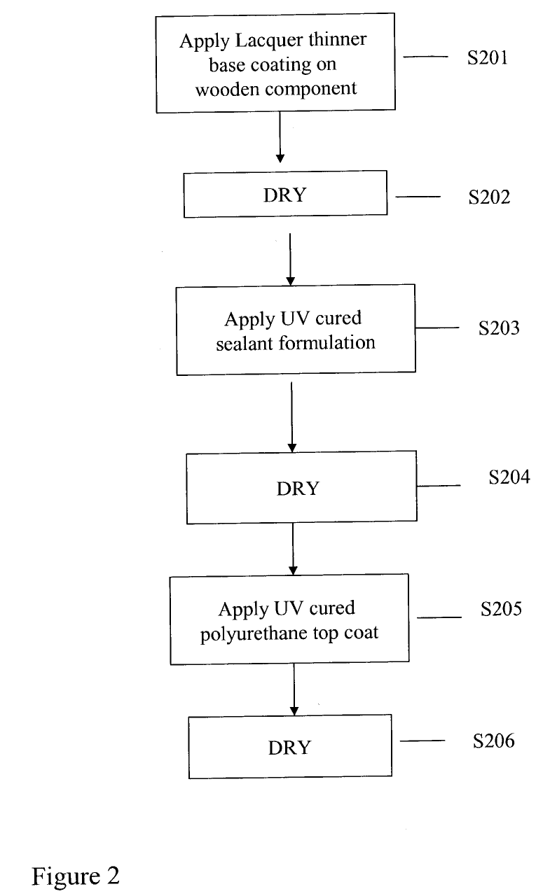

FIG. 2 illustrates the process steps for applying coats of thinner base, a clear UV-cured sealant formulation and a polymer coating as a finishing or top coat on the fire retardant-treated wooden slats.

In step S201, a lacquer thinner base coating is applied on the fire retardant-treated wooden slats using a flow coat application method.

In step S202, the lacquer thinner base is oven dried at a moderately elevated temperature of about 35° C.-46° C. for a time period of 3-5 minutes. In a preferred embodiment, the lacquer thinner base coat is dried at a temperature of about 40° C. for 5 minutes.

Next, in step S203, a UV-cured sealant formulation is applied on the lacquer-coated wooden slats at 0.15 to 0.20 gram weight thickness using a rollcoat application method.

In step S204, the UV-cured sealant formulation is flash dried at a high temperature of about 700° C.

Next, in step S205, a finishing coating of UV-cured polyurethane formulation is applied on the sealant-coated wooden slats at 0.10 to 0.15 gram weight thickness using a rollcoat application method.

In step S206, the UV-cured polyurethane-coated wooden slats are flash dried at a high temperature of about 700° C.

It is within the scope of the present invention to apply the lacquer coating by spraying, curtain coating, or roller coating. It is also within the scope of the present invention to spray or curtain coat the UV-cured sealant formulation and polyurethane formulation as a finishing coat on the wooden components.

Table I shows the results of the NFPA 701 Fire Test 1 (SMALL) 1996 Edition “Standard Methods of Fire Tests for Flame Resistant Textiles and Films” on 6 in. (15.2 cm) long pieces of slats mechanically fastened together to form a specimen 6 in. (15.2 cm) wide and 16 in. (40.6 cm) long.

| | | | | | Time of |
|---|---|---|---|---|---|
| | Initial | Final | Weight | Percent | Flaming of |
| Specimen | Weight | Weight | Loss | Weight | Pieces on |
| No. | gms | gms | gms | Loss | floor(seconds) |
| 1 | 227.7 | 201.3 | 26.4 | 11.6 | 0 |
| 2 | 227.7 | 200.6 | 27.1 | 11.9 | 0 |
| 3 | 237 | 178.9 | 58.1 | 24.5 | 0 |
| 4 | 234.2 | 215.9 | 18.3 | 7.8 | 0 |
| 5 | 227 | 195.3 | 31.7 | 14.0 | 0 |
| 6 | 232.4 | 204.7 | 27.7 | 11.9 | 0 |
| 7 | 225 | 202.8 | 22.2 | 9.9 | 0 |
| 8 | 233.5 | 124.4 | 109.1 | 46.7 | 0 |
| 9 | 232 | 156.8 | 75.2 | 32.4 | 0 |
| 10 | 241 | 140.5 | 100.5 | 41.7 | 0 |

21.2 Average Percent Weight Loss
13.5 Standard Deviation
0 Average Time of Flaming of Pieces on the Floor

The test results tabulated above clearly indicate that in case of fire, the fire retardant-treated wooden components of the present invention merely suffer a weight loss of 21.2% as compared to the industrial standard of weight loss of 40%. Thus wooden component of the present invention demonstrate excellent flame retardant properties exceeding even the standard industrial requirements.

While the invention has been described in terms of what are presently considered to be the preferred embodiments, it is to be understood that the invention need not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. A method of manufacturing a wooden component, comprising the steps of:
(a) pressure treating a piece of lumber with a fire-retardant solution;
(b) drying the pressure treated piece of lumber to a moisture content of 15-23%;
(c) cutting the piece of lumber into wooden components of the desired dimensions;
(d) applying a coat of lacquer thinner base to the wooden components;
(e) drying the base thinner coat;
(f) applying a UV cured sealant coating on the dried base coat;
(g) drying the sealant coat;
(h) applying a UV cured polyurethane top coat on the sealant coated wooden components; and
(i) curing the polymer coating.

2. The method of claim 1, wherein the lacquer coating is a composition consisting essentially of light aliphatic naphtha and toluene.

3. The method of claim 2, wherein the lacquer coating composition additionally comprises conventional ingredients selected from surfactants, pigments and/or solvents.

4. The method of claim 1, wherein the UV-cured sealant coating is a composition comprising of Acrylated Oligomer, TRPGDA, Dipropyleneglycol Diacrylate and Photoinitiators.

5. The method of claim 1, wherein the UV-cured polymer top coat composition comprises Tripropylene Glycol Diacrylate, Epoxy Acrylate, NPG Propoxylate Diacrylate, Benzophenone, Trimethylolpropane Triacrylate, Acrylated Amine, Hydroxymethylphenylpropanone and Hydroxycyclohexylphenyl ketone.

6. The method of claim 5, wherein the UV-cured polymer top coat composition additionally comprises conventional ingredients selected from additives and/or surfactants.

7. The method of claim 1, wherein the lacquer coating is applied on to the wooden component using a flow coat application method.

8. The method of claim 1, wherein lacquer coating is dried at an elevated temperature of about 35° C.-46.11° C.

9. The method of claim 1, wherein the UV cured sealant coating is applied on the lacquer coated wooden component at 0.15-0.20 gram weight thickness.

10. The method of claim 1, wherein UV cured sealant polymer coating is flash cured.

11. The method of claim 1, wherein UV cured polyurethane top coat is applied on the sealant coated wooden component at 0.15-0.20 gram weight thickness.

12. The method of claim 1, wherein UV cured polyurethane top coat is flash cured.

13. A fire retardant wooden component manufactured by a method comprising the steps of:
(a) pressure treating a piece of lumber with a fire-retardant solution;
(b) drying the pressure treated piece of lumber to a moisture content of 15-23%;
(c) cutting the piece of lumber into wooden components of the desired dimensions;
(d) applying a coat of lacquer thinner base to the wooden components;
(e) drying the base thinner coat;
(f) applying a UV cured sealant coating on the dried base coat;
(g) drying the sealant coat;
(h) applying a UV cured polyurethane top coat on the sealant coated wooden components; and
(i) curing the polymer coating.

14. The fire retardant wooden component of claim 13, wherein the lacquer coating is a composition consisting essentially of light aliphatic naphtha and toluene.

15. The fire retardant wooden component of claim 14, wherein the lacquer coating composition additionally comprises conventional ingredients selected from surfactants, pigments and/or solvents.

16. The fire retardant wooden component of claim 13, wherein the UV-cured sealant coating is a composition comprising of Acrylated Oligomer, TRPGDA, Dipropyleneglycol Diacrylate and Photoinitiators.

17. The fire retardant wooden component of claim 13, wherein the UV-cured polymer top coat composition comprises Tripropylene Glycol Diacrylate, Epoxy Acrylate, NPG Propoxylate Diacrylate, Benzophenone, Trimethylolpropane Triacrylate, Acrylated Amine, Hydroxymethylphenylpropanone and Hydroxycyclohexylphenyl ketone.

18. The fire retardant wooden component of claim 17, wherein the UV-cured polymer top coat composition additionally comprises conventional ingredients selected from additives and/or surfactants.

19. The fire retardant wooden component of claim 13, wherein the lacquer coating is applied on to the wooden component using a flow coat application method.

20. The fire retardant wooden component of claim 13, wherein lacquer coating is dried at an elevated temperature of about 35° C.-46.11° C.

21. The fire retardant wooden component of claim 13, wherein the UV cured sealant coating is applied on the lacquer coated wooden component at 0.15-0.20 gram weight thickness.

22. The fire retardant wooden component of claim 13, wherein UV cured sealant polymer coating is flash cured.

23. The fire retardant wooden component of claim 13, wherein UV cured polyurethane top coat is applied on the sealant coated wooden component at 0.15-0.20 gram weight thickness.

24. The fire retardant wooden component of claim 13, wherein UV cured polyurethane top coat is flash cured.

25. A fire retardant wooden component exhibiting an average weight loss of less than 40% when subjected to standard methods of fire tests for flame retardant resistant textiles and films NFPA 701 fire test 1 (small) 1996 Edition.

26. The fire retardant wooden component of claim 25, wherein the component exhibits an average weight loss of about 21.2% when subjected to standard methods of fire tests for flame retardant resistant textiles and films NFPA 701 fire test 1 (small) 1996 Edition.
